(19) United States
(12) Patent Application Publication
(10) Pub. No.: US 2020/0402710 A1
(43) Pub. Date: Dec. 24, 2020

(54) WELDING TRANSFORMER

(71) Applicant: VOLTER CO., LTD., Tokyo (JP)

(72) Inventors: Mitsuhiko UCHIDA, Tokyo (JP); Makoto KUDARA, Shirakawa-Shi (JP); Tamami OKA, Tokyo (JP)

(73) Assignee: VOLTER CO., LTD., Tokyo (JP)

(21) Appl. No.: 16/957,233

(22) PCT Filed: Dec. 27, 2018
(86) PCT No.: PCT/JP2018/048151

§ 371 Date: Jun. 23, 2020

(30) Foreign Application Priority Data
Dec. 27, 2017 (JP) 2017-252166

(51) Int. Cl. H01F 38/08; H01F 30/06; B23K 11/00; H01F 27/28; H01F 27/30

(52) U.S. Cl. CPC H01F 38/085; H01F 30/06; H01F 27/306; H01F 27/2852; B23K 11/00

(57) ABSTRACT

A welding transformer includes a core, and a primary winding and a secondary winding wound alternately around the core. The primary winding has a first strip-shaped conductor with the width direction thereof extending parallel to the direction Dy of flux passing through the core. The secondary winding has a second strip-shaped conductor with the width direction thereof extending parallel to the direction Dy of the flux passing through the core. The first strip-shaped conductor and the second strip-shaped conductor are laminated alternately in a direction Dx perpendicular to the direction Dy of the flux.

### TECHNICAL FIELD

The present invention relates to a welding transformer employed in resistance welding, for example.

### BACKGROUND ART

A welding transformer described in Japanese Patent No. 5220931 addresses a problem of enabling precise welding control of a large current at high speed, and reducing power consumption too.

In order to solve the above problem, the welding transformer described in Japanese Patent No. 5220931 comprises: an annular magnetic core; a dividedly wound primary coil; and a plurality of positive-side coils and a plurality of negative-side coils that are sandwiched alternately one at a time between each of gaps of the primary coil. The coils are fixed to one surface of a connecting substrate. On the other surface of the connecting substrate, the positive-side coil is electrically connected to a positive-side conductor via a first coupling electrode plate. The negative-side coil is electrically connected to a negative-side conductor via a second coupling electrode plate. A connecting section of the positive-side coil and the negative-side coil is electrically connected to a third coupling electrode plate. Across a thin insulating layer, the positive-side conductor, a rectifier element, and the first electrode plate are disposed on one side, and the negative-side conductor, a rectifier element, and the second electrode plate are disposed on the other side, and the first electrode plate and the second electrode plate are electrically connected by the third electrode plate.

### SUMMARY OF INVENTION

However, in the welding transformer described in Japanese Patent No. 5220931, a first unit having only the positive-side coils wound around therein, a second unit having only the primary coil wound around therein, and a third unit having only the negative-side coils wound around therein, are overlaid in this order to configure one structure. Then, a plurality of the structures are arranged in a transverse direction. Consequently, there is a problem that a plurality of coupling electrode plates for supporting the plurality of structures (the first coupling electrode plate, the second coupling electrode plate, and the third coupling electrode plate) become necessary, and the configuration becomes complicated.

The present invention, which has been made in view of such a problem, has an object of providing a welding transformer in which downsizing and weight-lightening can be achieved, and, moreover, highly efficient power conversion is possible with a high frequency large current.

[1] An aspect of the present invention includes: a core; and a primary winding and a secondary winding wound alternately around the core, the primary winding including a first band-shaped conductor whose width direction extends in parallel to a direction of a magnetic flux passing through the core, the secondary winding including a second band-shaped conductor whose width direction extends in parallel to the direction of the magnetic flux passing through the core, and the first band-shaped conductor and the second band-shaped conductor being laminated alternately in a direction orthogonal to the direction of the magnetic flux.

Performance of the welding transformer can be improved by increasing coupling between the primary winding and the secondary winding and by a decrease in high frequency loss, and this all depends on structure of the winding. To increase the coupling, which depends on an extent to which leakage magnetic flux can be reduced, the welding transformer according to the present invention has a structure described below.

That is, in the aspect of the present invention, the primary winding and the secondary winding that have been overlappingly wound in a perpendicular direction to the direction of the magnetic flux passing through an iron core are divided by winding number or cross-sectional area, the primary winding and the secondary winding are configured to be in alternate positions, and are connected in series or in parallel. As a result, coupling between a primary circuit and a secondary circuit can be increased.

Regarding increasing the coupling, a secondary side is short-circuited, and an inductance value seen from a primary side becomes smaller, so, compared to the case where inductance when not dividing has been assumed to be L, the inductance value decreases according to a division number. The decrease in the inductance value will have a value substantially inversely proportional to the division number.

A band-shaped conductor is used as a winding material, as a measure for reduction of high frequency loss. Since skin loss which is an inevitable accompaniment to high frequency current, of the band-shaped conductor is extremely small, and, moreover, since overcurrent loss due to the current, of the band-shaped conductor is small too, the band-shaped conductor is an ideal high frequency measure material. Moreover, although, generally, a litz wire is often used as a conductor for high frequency, the band-shaped conductor has fewer spaces (gaps) formed therein compared to, for example, a circular litz strand, hence an occupancy rate can be set large, and downsizing/weight-lightening becomes possible.

[2] In an aspect of the present invention, the secondary winding includes a positive electrode side secondary winding and a negative electrode side secondary winding, and the primary winding, the positive electrode side secondary winding, and the negative electrode side secondary winding are wound around the core in this order, or the primary winding, the negative electrode side secondary winding, and the positive electrode side secondary winding are wound around the core in this order. As a result, increase in coupling between the primary winding and the secondary winding and decrease in high frequency loss can be realized.

Moreover, a rise of primary current can be made steep, and, accordingly, it becomes possible for the primary current to be made higher frequency, and for a rise of secondary current to be increased. As a result, fine control becomes possible. In addition, since a workpiece (a material) can be supplied with a high current for a short time, welding on a workpiece of high electrical conductivity, such as aluminum or copper, becomes easy too.

[3] In an aspect of the present invention, there are included: the core having an annular shape; a wound section wound around the annular core and including the primary winding connected between one input terminal and another input terminal, the positive electrode side secondary winding, and the negative electrode side secondary winding; a minus electrode connected to a connecting point of the positive electrode side secondary winding and the negative electrode side secondary winding; and a plus electrode connected via a first rectifying element to the positive electrode side secondary winding and connected via a second rectifying element to the negative electrode side secondary winding.
[4] In an aspect of the present invention, the primary winding includes a plurality of the first band-shaped conductors covering a part of the core, the positive electrode side secondary winding includes a plurality of the second band-shaped conductors respectively disposed between the first band-shaped conductors, the negative electrode side secondary winding includes a plurality of third band-shaped conductors respectively disposed between the first band-shaped conductors and the second band-shaped conductors, the second band-shaped conductors each have one end section to which a positive electrode is connected, and are each wound around with at least one turn, the third band-shaped conductors each have one end section to which a negative electrode is connected, and are each wound around with at least one turn, and the minus electrode electrically connecting another end section of the second band-shaped conductor and another end section of the third band-shaped conductor is disposed between each of the positive electrodes and each of the negative electrodes.

The primary winding includes the plurality of first band-shaped conductors covering a part of the core, the positive electrode side secondary winding includes the plurality of second band-shaped conductors respectively disposed between the first band-shaped conductors, and the negative electrode side secondary winding includes the plurality of third band-shaped conductors respectively disposed between the first band-shaped conductors and the second band-shaped conductors. Moreover, the second band-shaped conductors each have one end section to which the positive electrode is connected, and are each wound around with at least one turn, the third band-shaped conductors each have one end section to which the negative electrode is connected, and are each wound around with at least one turn. As a result, the wound section can be made compact, and downsizing of the welding transformer can be achieved.

Moreover, since the minus electrode is disposed between each of the positive electrodes and each of the negative electrodes, and the other end section of the second band-shaped conductor and the other end section of the third band-shaped conductor are electrically connected, the minus electrode can be easily connected to the wound section. In particular, the minus electrode can be tap-connected to the secondary winding, and the positive electrode side secondary winding and the negative electrode side secondary winding can be configured in the wound section.

Furthermore, in the aspect of the present invention, inclusion of the above-mentioned configuration results in the following advantages being exhibited. That is, generally, when frequency is raised, an iron core can be made smaller, hence downsizing of the welding transformer can be achieved. However, when frequency is raised, efficiency of the transformer drops, hence there has been a limit to downsizing.

To address this situation, in the aspect of the present invention, since rise of the primary current becomes steep, a period during which a secondary voltage can be effectively output can be lengthened, and, even if frequency is raised, efficiency of the transformer can be increased, and, moreover, downsizing can be achieved too.

[5] In an aspect of the present invention, the primary winding includes a plurality of first coupling conductors configured to respectively electrically connect between the first band-shaped conductors, the positive electrode side secondary winding includes a plurality of second coupling conductors configured to respectively electrically connect between the positive electrodes, the negative electrode side secondary winding includes a plurality of third coupling conductors configured to respectively electrically connect between the negative electrodes, and the positive electrode side secondary winding and the negative electrode side secondary winding include a plurality of fourth coupling conductors configured to respectively electrically connect between the minus electrodes.

By electrically connecting between the first band-shaped conductors respectively by the first coupling conductors, the primary winding can be configured, and lead-out of the primary winding to outside of the wound section becomes easy. Moreover, by electrically connecting between the positive electrodes respectively by the second coupling conductors, the positive electrode side secondary winding can be configured, and lead-out of the positive electrode side secondary winding to outside of the wound section becomes easy. Similarly, by electrically connecting between the negative electrodes respectively by the third coupling conductors, the negative electrode side secondary winding can be configured, and lead-out of the negative electrode side secondary winding to outside of the wound section becomes easy.

[6] In an aspect of the present invention, the plurality of first coupling conductors are formed on one end surface of the wound section, the one input terminal is connected to the first coupling conductor positioned on an outer circumferential side of the wound section, among the plurality of first coupling conductors, and the other input terminal is connected to the first coupling conductor positioned on an inner circumferential side of the wound section, among the plurality of first coupling conductors.

Since the first coupling conductors are formed on the one end surface of the wound section, in-betweens of the first band-shaped conductors can be easily electrically connected by the first coupling conductors, and the primary winding can be easily configured. Moreover, lead-out of the primary winding to outside of the wound section becomes easy too. As a result, the one input terminal can be connected to the first coupling conductor positioned on the outer circumferential side of the wound section, among the plurality of first coupling conductors, and the other input terminal can be connected to the first coupling conductor positioned on the inner circumferential side of the wound section, among the plurality of first coupling conductors.

[7] In an aspect of the present invention, the core includes two long parallel sections, the wound section is wound around either one of the parallel sections, and at least one coupling direction of a coupling direction of the first coupling conductor, a coupling direction of the second coupling conductor, a coupling direction of the third coupling conductor, and a coupling direction of the fourth coupling conductor, and a long direction of the parallel section, are in an intersecting positional relationship. Now, an intersecting relationship refers to a relationship where an angle made by the at least one coupling direction and the long direction of the parallel section is 60°-120°, and, preferably, is 90° (an orthogonal relationship).

This makes it possible for the first coupling conductor to be disposed in an upper section or lower section of the wound section, and for any one of the second coupling conductor, the third coupling conductor, and the fourth coupling conductor to be disposed in the lower section or upper section of the wound section, and contributes to the welding transformer being made compact. In particular, by configuring all of the coupling directions of the second coupling conductor, the third coupling conductor, and the fourth coupling conductor to be in an intersecting positional relationship with the long direction of the parallel section, all of the second coupling conductor, the third coupling conductor, and the fourth coupling conductor can be disposed in the lower section or upper section of the wound section, and even more compacting of the welding transformer can be achieved.

[8] In an aspect of the present invention, at least the coupling direction of the second coupling conductor is identical to the coupling direction of the third coupling conductor.

Thus, the second coupling conductor and the third coupling conductor can be disposed in parallel to be configured as one pedestal, and the two rectifying elements, the plus electrode, and so on can be disposed on this pedestal. As a result, compacting of the welding transformer can be achieved.

[9] In an aspect of the present invention, the wound section includes: a first wound section wound around one of the parallel sections; and a second wound section wound around another of the parallel sections, and the wound section further includes a fifth coupling conductor configured to electrically connect at least one of the first band-shaped conductors of the first wound section and at least one of the first band-shaped conductors of the second wound section.

Even in the case where the wound section is configured by the first wound section and the second wound section, one primary winding can be configured by electrically connecting the first band-shaped conductor of the first wound section and the first band-shaped conductor of the second wound section by the fifth coupling conductor. Therefore, the welding transformer of a type having one wound section and the welding transformer of a type having two wound sections can be provided, and selection can be made variously according to application.

[10] In an aspect of the present invention, one group of one or more first coupling conductors, among the plurality of first coupling conductors, is formed on one end surface of the first wound section, another group of one or more first coupling conductors, among the plurality of first coupling conductors, is formed on one end surface of the second wound section, the fifth coupling conductor is connected from a position corresponding to the first coupling conductor positioned on an outer circumferential side or an inner circumferential side of the first wound section, among the one or more first coupling conductors of the one group, to a position corresponding to the first coupling conductor positioned on an outer circumferential side or an inner circumferential side of the second wound section, among the one or more first coupling conductors of the other group, the one input terminal is connected to the first coupling conductor positioned on the inner circumferential side or the outer circumferential side of the first wound section, among the one or more first coupling conductors of the one group, and the other input terminal is connected to the first coupling conductor positioned on the inner circumferential side or the outer circumferential side of the second wound section, among the one or more first coupling conductors of the other group.

Among the plurality of first coupling conductors, some first coupling conductors can be formed on the one end surface of the first wound section, and other first coupling conductors can be formed on the one end surface of the second wound section. Moreover, the fifth coupling conductor can be connected to the first coupling conductor positioned on the outer circumferential side or the inner circumferential side of the first wound section, among the some first coupling conductors, and to the first coupling conductor positioned on the outer circumferential side or the inner circumferential side of the second wound section, among the other first coupling conductors.

As a result, in-betweens of the first band-shaped conductors in the first wound section can be easily electrically connected by the some first coupling conductors. Similarly, in-betweens of the first band-shaped conductors in the second wound section can be easily electrically connected by the other first coupling conductors. That is, one primary winding can be easily configured spanning the first wound section and the second wound section. Moreover, lead-out of the primary winding to outside of the first wound section and to outside of the second wound section becomes easy too.

As a result, the one input terminal can be connected to the first coupling conductor positioned on the inner circumferential side or the outer circumferential side of the first wound section, among the some first coupling conductors, and the other input terminal can be connected to the first coupling conductor positioned on the inner circumferential side or the outer circumferential side of the second wound section, among the other first coupling conductors.

[11] In an aspect of the present invention, the core includes two long parallel sections, the first wound section is wound around either one of the parallel sections, the second wound section is wound around either another of the parallel sections, and at least one coupling direction of a coupling direction of the first coupling conductor, a coupling direction of the second coupling conductor, a coupling direction of the third coupling conductor, and coupling directions of the fourth coupling conductor and the fifth coupling conductor, and a long direction of the parallel section, are in an intersecting positional relationship.

Now, an intersecting relationship refers to a relationship where an angle made by the at least one coupling direction and the long direction of the parallel section is 60°-120°, and, preferably, is 90° (an orthogonal relationship).

This makes it possible for the first coupling conductor to be disposed in upper sections or lower sections of the first wound section and the second wound section, and for any one of the second coupling conductor, the third coupling conductor, and the fourth coupling conductor to be disposed in the lower sections or upper sections of the first wound section and the second wound section, and contributes to the welding transformer being made compact. In particular, by configuring all of the coupling directions of the second coupling conductor, the third coupling conductor, and the fourth coupling conductor to be in an intersecting positional relationship with the long direction of the parallel section, all of the second coupling conductor, the third coupling conductor, and the fourth coupling conductor can be disposed in the lower sections or upper sections of the first wound section and the second wound section, and even more compacting of the welding transformer can be achieved.

[12] In an aspect of the present invention, at least the coupling direction of the second coupling conductor, the coupling direction of the third coupling conductor, and the coupling direction of the fifth coupling conductor are identical.

Thus, the second coupling conductor and the third coupling conductor can be disposed in parallel to be configured as one pedestal, and the two rectifying elements, the plus electrode, and so on can be disposed on this pedestal. As a result, compacting of the welding transformer can be achieved. Moreover, since the coupling direction of the fifth coupling conductor is also the same, lead-out directions of the one input terminal and the other input terminal can be easily grasped too, and mounting work of the welding transformer becomes easy.

[13] In an aspect of the present invention, there are further included: a positive electrode conductor connected to the second coupling conductor; and a negative electrode conductor connected to the third coupling conductor, the plus electrode is connected between the positive electrode conductor and the negative electrode conductor, the first rectifying element is connected between the positive electrode conductor and the plus electrode, and the second rectifying element is connected between the negative electrode conductor and the plus electrode.

This makes it possible for a combined structure of the positive electrode conductor, the first rectifying element, the plus electrode, the second rectifying element, and the negative electrode conductor to be disposed on one end surface side of the wound section, and contributes to the welding transformer being made compact.

[14] In an aspect of the present invention, the plurality of fourth coupling conductors electrically connecting between the minus electrodes, and the plus electrode are disposed on one end surface side of the wound section, and the one input terminal and the other input terminal are disposed on another end surface side of the wound section.

As a result, the welding machine to be connected to the welding transformer can be disposed on the plus electrode and the minus electrode disposed on the one end surface side of the wound section, and the prior-stage circuit to be connected to the welding transformer can be disposed on the one input terminal and the other input terminal disposed on the other end surface side of the wound section. In other words, in the welding transformer, a portion where the welding machine is connected and a portion where the prior-stage circuit is connected can be clearly separated, whereby faulty connection can be prevented in advance, and an improvement in work efficiency can be achieved.

With the welding transformer according to the present invention, downsizing and weight-lightening can be achieved, and, moreover, highly efficient power conversion becomes possible with a high frequency large current.

### BRIEF DESCRIPTION OF DRAWINGS

FIG. 1 is a cross-sectional view showing a welding transformer according to the present embodiment, with a part thereof omitted;

FIG. 2 is a circuit diagram showing a schematic configuration of a welding transformer according to a first embodiment (a first welding transformer), along with a welding machine;

FIG. 3A is a perspective view showing the first welding transformer seen from one direction, and FIG. 3B is a perspective view showing the first welding transformer seen from another direction;

FIG. 4 is an exploded perspective view showing a configuration of the first welding transformer;

FIG. 5A is a perspective view showing mainly a configuration of a wound section of the first welding transformer seen from one direction, and FIG. 5B is a plan view showing a winding structure of the wound section seen from another direction;

FIG. 6 is a cross-sectional view taken along the line VI-VI of FIG. 5B;

FIG. 7 is a cross-sectional view taken along the line VII-VII of FIG. 5B;

FIGS. 8A and 8B are perspective views showing a winding state of a positive electrode side secondary winding (a second band-shaped conductor) and a negative electrode side secondary winding (a third band-shaped conductor), and a dispositional relationship of a positive electrode, a negative electrode, and a minus electrode;

FIG. 9A is a view showing a primary current waveform of a working example, and FIG. 9B is a view showing a primary current waveform of a comparative example;

FIG. 10A is a perspective view showing a welding transformer according to a second embodiment (a second welding transformer) seen from one direction, and FIG. 10B is a perspective view showing the second welding transformer seen from another direction;

FIG. 11A is a perspective view showing mainly a configuration of a wound section of the second welding transformer seen from one direction, and FIG. 11B is a plan view showing a winding structure of the wound section seen from another direction;

FIG. 12 is a cross-sectional view taken along the line XII-XII of FIG. 11B;

FIG. 13 is a cross-sectional view taken along the line XIII-XIII of FIG. 11B;

FIG. 14A is a perspective view showing mainly configurations of a first primary winding and a second primary winding of the second welding transformer seen from one direction, and FIG. 14B is an enlarged view showing configurations of a first coupling conductor and a fifth coupling conductor; and

FIG. 15 is an exploded perspective view showing a configuration of the second welding transformer.

### DESCRIPTION OF EMBODIMENTS

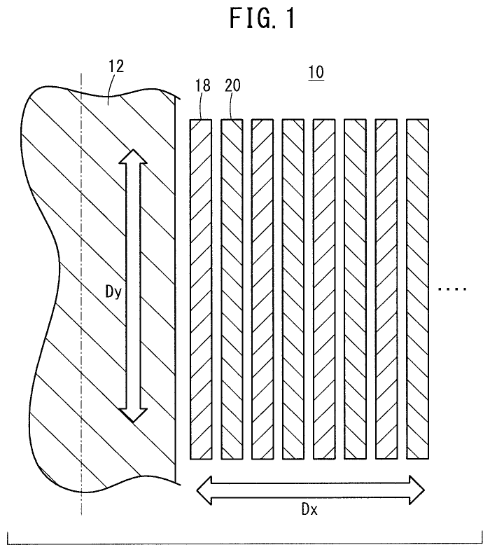

Embodiments of a welding transformer according to the present invention will be described below with reference to FIGS. 1-15.

First, a basic configuration of a welding transformer 10 according to the present embodiment will be described with reference to FIG. 1.

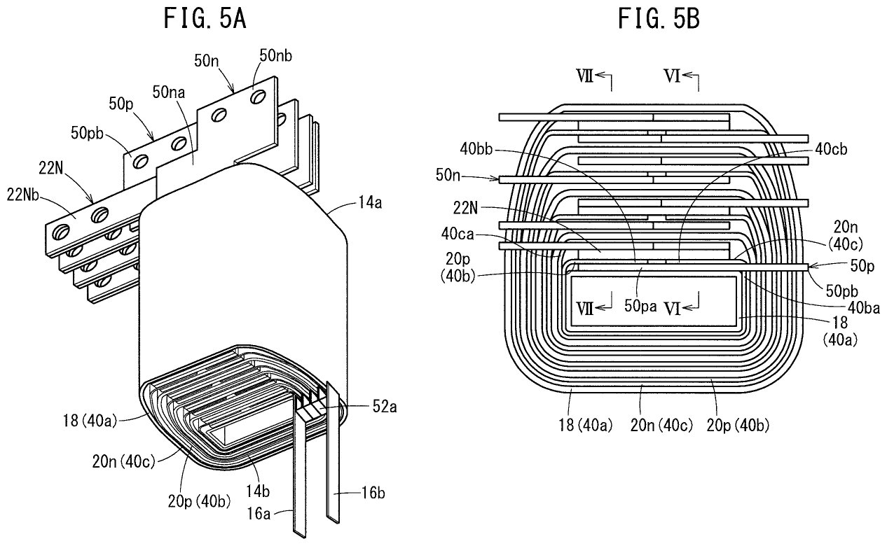

As shown in FIG. 1, the basic configuration of the welding transformer 10 includes: a core 12; and a primary winding 18 and a secondary winding 20 wound alternately around the core 12. The primary winding 18 includes a first band-shaped conductor 40a (refer to FIG. 5A) whose width direction extends in parallel to a direction Dy of a magnetic flux passing through the core 12. The secondary winding 20 includes a second band-shaped conductor 40b whose width direction extends in parallel to the direction Dy of the magnetic flux passing through the core 12. The first band-shaped conductor 40a and the second band-shaped conductor 40b (refer to FIG. 5A) are laminated alternately in a direction Dx orthogonal to the direction Dy of the magnetic flux.

Performance of the welding transformer 10 can be improved by increasing coupling between the primary winding 18 and the secondary winding 20 and by a decrease in high frequency loss, and this all depends on structure of the winding.

To increase the coupling, which depends on an extent to which leakage magnetic flux can be reduced, the welding transformer 10 according to the present embodiment has the configuration mentioned above. That is, by dividing by winding number or cross-sectional area the primary winding 18 and the secondary winding 20 that have been overlappingly wound in the direction Dx perpendicular to the direction Dy of the magnetic flux passing through the core 12, by configuring the primary winding 18 and the secondary winding 20 to be in alternate positions, and by connecting them in series or in parallel, coupling between a primary circuit and a secondary circuit can be increased.

Regarding increasing the coupling, a secondary side is short-circuited, and an inductance value seen from a primary side becomes smaller, so, compared to the case where inductance when not dividing has been assumed to be L, the inductance value decreases according to a division number. The decrease in the inductance value will have a value substantially inversely proportional to the division number.

Furthermore, in the present embodiment, a band-shaped conductor is used as a winding material, as a measure for reduction of high frequency loss. Although a high frequency current has a property of flowing only in a conductor surface due to a skin effect, thickness of the band-shaped conductor is small, hence the current can be caused to flow in the whole of the conductor, and, as a result, skin loss is extremely small. Moreover, since overcurrent loss due to the current is small too, the band-shaped conductor is an ideal high frequency measure material. Moreover, although, generally, a litz wire is often used as a conductor for high frequency, the band-shaped conductor has fewer spaces (gaps) formed therein compared to, for example, a circular litz strand, hence an occupancy rate can be set large, and downsizing/weight-lightening becomes possible.

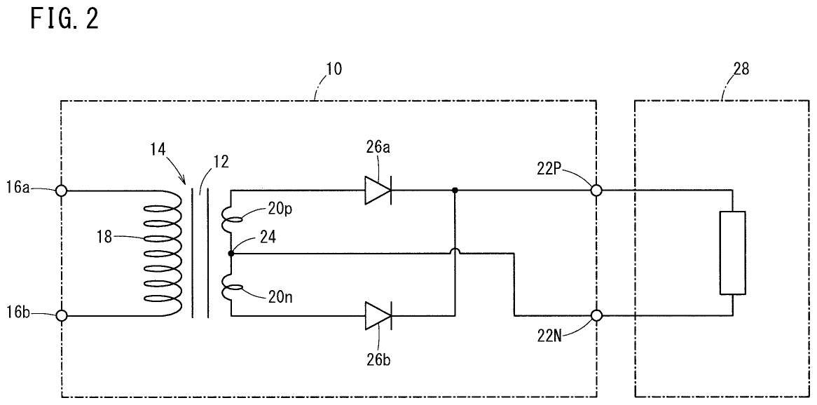

Next, preferred application examples of the welding transformer 10 according to the present embodiment will be described with reference to FIGS. 2-15.

As shown in the circuit diagram of FIG. 2, the welding transformer 10 includes: the core 12; and a wound section 14 wound around the core 12. The wound section 14 includes: the primary winding 18 connected between one input terminal 16a and another input terminal 16b; a positive electrode side secondary winding 20p; and a negative electrode side secondary winding 20n. In addition, the welding transformer 10 includes a minus electrode 22N and a plus electrode 22P. The minus electrode 22N is connected to a connecting point 24 (a tap) of the positive electrode side secondary winding 20p and the negative electrode side secondary winding 20n. The plus electrode 22P is connected via a first rectifying element 26a to the positive electrode side secondary winding 20p, and is connected via a second rectifying element 26b to the negative electrode side secondary winding 20n.

The welding transformer 10 has connected thereto, via the one input terminal 16a and the other input terminal 16b, an unillustrated prior-stage circuit (for example, an inverter), and has connected thereto via the minus electrode 22N and the plus electrode 22P a welding machine 28.

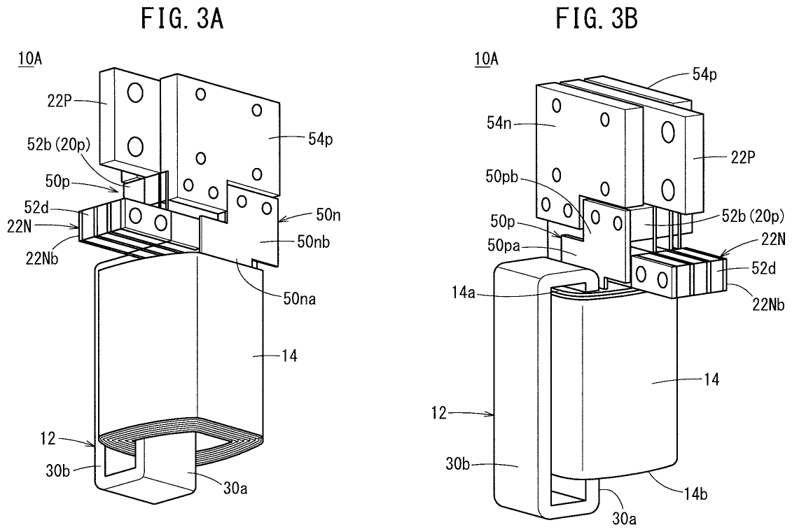

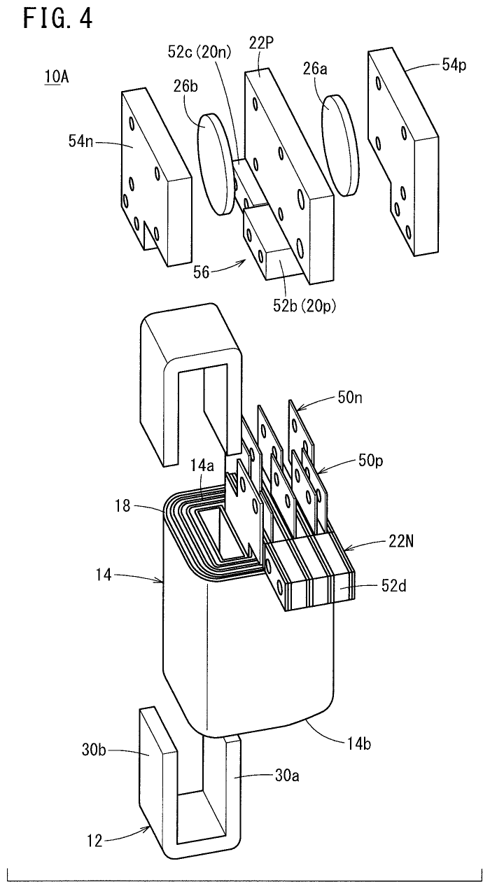

Moreover, as shown in FIGS. 3A-4, in a welding transformer according to a first embodiment (hereafter, written as first welding transformer 10A), the core 12 having an annular shape has two long parallel sections (a first parallel section 30a and a second parallel section 30b), and the wound section 14 is wound around either one of the parallel sections (for example, the first parallel section 30a).

As shown in FIGS. 5A and 5B, the primary winding 18 configuring the wound section 14 includes, for example, five of the first band-shaped conductors 40a covering a part of the annular core 12. The positive electrode side secondary winding 20p includes, for example, four of the second band-shaped conductors 40b respectively disposed between the first band-shaped conductors 40a. The negative electrode side secondary winding 20n includes, for example, four of third band-shaped conductors 40c respectively disposed between the first band-shaped conductors 40a and the second band-shaped conductors 40b.

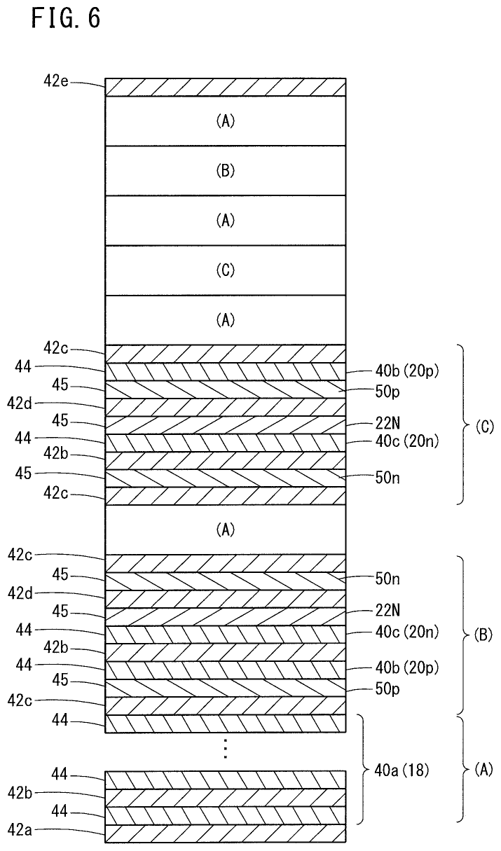

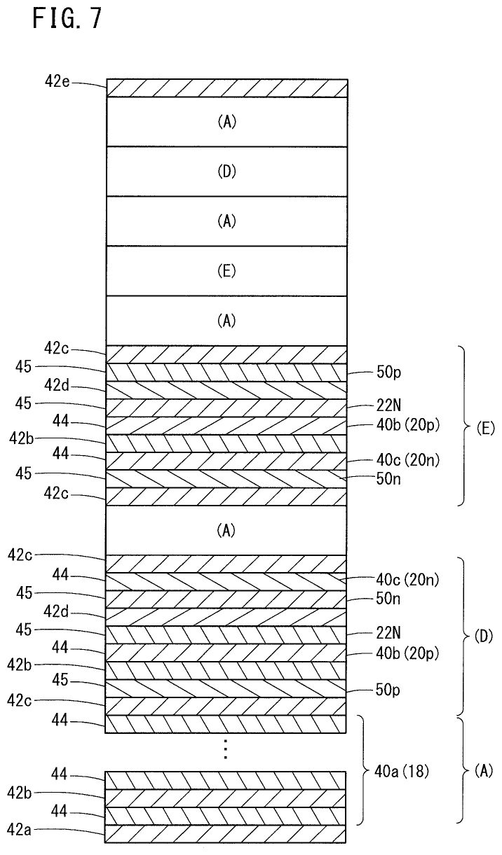

As shown in FIGS. 6 and 7, the first band-shaped conductor 40a is configured by alternately laminating insulating films 42 and conductive films 44 in a manner of an inner insulating film 42a, the conductive film 44, an inter-layer insulating film 42b, the conductive film 44, the inter-layer insulating film 42b, . . . , the conductive film 44.

Among the five first band-shaped conductors 40a, the outermost side first band-shaped conductor 40a and the innermost side first band-shaped conductor 40a each have at least one turn, for example, five turns of the conductive films 44 wound around therein, and the central three first band-shaped conductors 40a each have at least one turn, for example, eight turns of the conductive films 44 wound around therein. That is, a total of at least five turns, for example, 34 turns of the conductive films 44 are wound around. Now, a dispositional configuration of the first band-shaped conductor 40a is assumed to be (A).

Moreover, when viewed in the cross section taken along the line VI-VI of FIG. 5B, as shown in FIG. 6, the second band-shaped conductor 40b is configured by the conductive film 44, has connected to its inner end surface a positive electrode 50p configured by a metal plate 45, for example, and is wound around with at least one turn. Note that an inter-winding insulating film 42c is interposed between the outer conductive film 44 of the first band-shaped conductor 40a and the positive electrode 50p.

The third band-shaped conductor 40c is configured by the conductive film 44, has connected to its outer end surface the minus electrode 22N configured by the metal plate 45, for example, and is wound around with at least one turn. The inter-layer insulating film 42b is interposed between the conductive film 44 of the second band-shaped conductor 40b and the conductive film 44 of the third band-shaped conductor 40c. A negative electrode 50n configured by the metal plate 45 is disposed, via an inter-electrode insulating film 42d, on an outer end surface of the minus electrode 22N. The inter-winding insulating film 42c is disposed on an outer end surface of the negative electrode 50n. Now, a dispositional configuration from the above-mentioned inter-winding insulating film 42c disposed on an outer end surface of the first band-shaped conductor 40a to the above-mentioned inter-winding insulating film 42c disposed on the outer end surface of the negative electrode 50n, is assumed to be (B).

The first band-shaped conductor 40a is disposed, via the inter-winding insulating film 42c, on the outer end surface of the negative electrode 50n, and the inter-winding insulating film 42c, the negative electrode 50n, the inter-layer insulating film 42b, the third band-shaped conductor 40c, the minus electrode 22N, the inter-electrode insulating film 42d, the positive electrode 50p, the second band-shaped conductor 40b, and the inter-winding insulating film 42c are disposed on the outer end surface of the first band-shaped conductor 40a. Now, a dispositional configuration from the above-mentioned inter-winding insulating film 42c disposed on the outer end surface of the first band-shaped conductor 40a to the above-mentioned inter-winding insulating film 42c disposed on an outer end surface of the second band-shaped conductor 40b, is assumed to be (C).

Moreover, the dispositional configurations (A), (C), (A), (B), and (A) are disposed on an outer end surface of the above-mentioned dispositional configuration (C), and, furthermore, an outer insulating film 42e is disposed on an outside of the most outwardly positioned first band-shaped conductor 40a.

Similarly, when viewed in the cross section taken along the line VII-VII of FIG. 5B, as shown in FIG. 7, the second band-shaped conductor 40b has disposed on its inner end surface the positive electrode 50p via the inter-layer insulating film 42b, has connected to its outer end surface the minus electrode 22N, and is wound around with at least one turn. Note that the inter-winding insulating film 42c is interposed between the outer conductive film 44 of the first band-shaped conductor 40a and the positive electrode 50p.

The third band-shaped conductor 40c has connected to its inner end surface the negative electrode 50n, and is wound around with at least one turn. The inter-electrode insulating film 42d is interposed between the negative electrode 50n and the minus electrode 22N. That is, the negative electrode 50n, the inter-electrode insulating film 42d, and the minus electrode 22N are interposed between the second band-shaped conductor 40b and the third band-shaped conductor 40c. Now, a dispositional configuration from the above-mentioned inter-winding insulating film 42c disposed on the outer end surface of the first band-shaped conductor 40a to the above-mentioned inter-winding insulating film 42c disposed on an outer end surface of the third band-shaped conductor 40c, is assumed to be (D).

The first band-shaped conductor 40a is disposed, via the inter-winding insulating film 42c, on the outer end surface of the negative electrode 50n, and the inter-winding insulating film 42c, the negative electrode 50n, the third band-shaped conductor 40c, the inter-layer insulating film 42b, the second band-shaped conductor 40b, the minus electrode 22N, the inter-electrode insulating film 42d, the positive electrode 50p, and the inter-winding insulating film 42c are disposed on the outer end surface of the first band-shaped conductor 40a. Now, a dispositional configuration from the above-mentioned inter-winding insulating film 42c disposed on the outer end surface of the first band-shaped conductor 40a to the above-mentioned inter-winding insulating film 42c disposed on an outer end surface of the positive electrode 50p, is assumed to be (E).

Moreover, the dispositional configurations (A), (E), (A), (D), and (A) are disposed on an outer end surface of the above-mentioned dispositional configuration (E), and, furthermore, the outer insulating film 42e is disposed on an outside of the most outwardly positioned first band-shaped conductor 40a.

The above-mentioned dispositional configurations are merely one example, and a variety of winding structures can be realized by appropriately disposing the above-mentioned dispositional configurations (B)-(E) while interposing the dispositional configuration (A).

Note that widths of the first band-shaped conductor 40a, the second band-shaped conductor 40b, and the third band-shaped conductor 40c are 60-400 mm. Moreover, the inner insulating film 42a, the inter-layer insulating film 42b, the inter-winding insulating film 42c, the inter-electrode insulating film 42d, and the outer insulating film 42e are made of insulating paper, resin, enamel, or the like, and have thicknesses of 0.05-0.25 mm. The conductive layer 44 is made of aluminum, an aluminum alloy, copper, a copper alloy, or the like, and has a thickness of 0.1-3.0 mm.

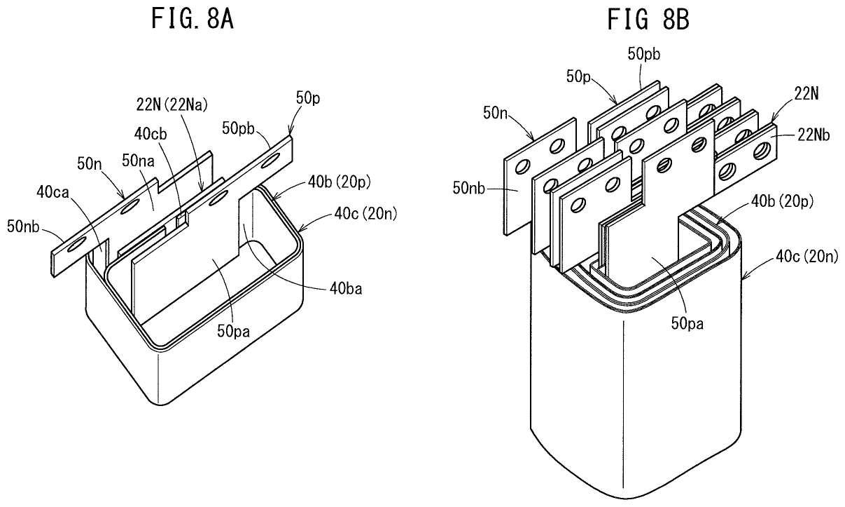

As shown in FIGS. 8A and 8B, the positive electrode 50p is configured by a metal plate of aluminum, an aluminum alloy, copper, or a copper alloy, for example, and is configured by integrally forming: a positive electrode main body 50pa extending along an axial direction of the wound section 14; and a positive electrode attaching section 50pb extending in a transverse direction from, for example, an upper section of the positive electrode main body 50pa. A thickness of the positive electrode 50p is 0.1-3.0 mm.

The negative electrode 50n is configured by a metal plate of aluminum, an aluminum alloy, copper, or a copper alloy, for example, and is configured by integrally forming: a negative electrode main body 50na extending along the axial direction of the wound section 14; and a negative electrode attaching section 50nb extending in a transverse direction from, for example, an upper section of the negative electrode main body 50na. A thickness of the negative electrode 50n is 0.1-3.0 mm.

The minus electrode 22N is configured by a metal plate of aluminum, an aluminum alloy, copper, or a copper alloy, for example, and is configured by integrally forming: a minus electrode main body 22Na (refer to FIG. 8A) extending along the axial direction of the wound section 14; and a minus electrode attaching section 22Nb (refer to FIG. 8B) extending in a transverse direction from, for example, an upper section of the minus electrode main body 22Na. A thickness of the minus electrode main body 22Na is 0.1-3.0 mm, and a thickness of the minus electrode attaching section 22Nb is 0.1-3.0 mm.

As shown in FIG. 5A, the primary winding 18 includes a plurality of first coupling conductors 52a, for example, four first coupling conductors 52a that respectively electrically connect between the first band-shaped conductors 40a. The first coupling conductor 52a is configured by a thin U-shaped metal plate, for example. The plurality of first coupling conductors 52a are formed on another end surface 14b (being the other end surface with respect to a later-mentioned one end surface 14a) of the wound section 14. The one input terminal 16a, for example, is connected to the first coupling conductor 52a positioned on an inner circumferential side of the wound section 14, among the plurality of first coupling conductors 52a, and the other input terminal 16b, for example, is connected to the first coupling conductor 52a positioned on an outer circumferential side of the wound section 14, among the plurality of first coupling conductors 52a.

As shown in FIGS. 3A and 3B, the positive electrode side secondary winding 20p includes a plurality of second coupling conductors 52b that respectively electrically connect between the positive electrodes 50p in a transverse direction. The second coupling conductor 52b is configured by a block-like metal plate, for example, which is connected between the positive electrode attaching sections 50pb.

On the other hand, as shown in FIG. 4, the negative electrode side secondary winding 20n includes a plurality of third coupling conductors 52c that respectively electrically connect between the negative electrodes 50n in a transverse direction. The third coupling conductor 52c is configured by a block-like metal plate, for example, which is connected between the negative electrode attaching sections 50nb (refer to FIG. 3A). Moreover, as shown in FIG. 4, the positive electrode side secondary winding 20p and the negative electrode side secondary winding 20n include a plurality of fourth coupling conductors 52d that respectively electrically connect between the minus electrodes 22N. The fourth coupling conductor 52d is configured by a block-like metal plate, for example, which is connected between the minus electrode attaching sections 22Nb (refer to FIG. 3A).

Moreover, at least one coupling direction of a coupling direction of the first coupling conductor 52a, a coupling direction of the second coupling conductor 52b, a coupling direction of the third coupling conductor 52c, and a coupling direction of the fourth coupling conductor 52d, and a long direction of the core 12 (the first parallel section 30a and the second parallel section 30b), are in an intersecting positional relationship. The intersecting relationship refers to a relationship where an angle made by at least the above-described one coupling direction and the long direction of the core 12 is 60°-120°, and, preferably, is 90° (an orthogonal relationship). In this first welding transformer 10A, all of the coupling direction of the first coupling conductor 52a, the coupling direction of the second coupling conductor 52b, the coupling direction of the third coupling conductor 52c, and the coupling direction of the fourth coupling conductor 52d, and the long direction of the core 12, are in the intersecting positional relationship.

In addition, as shown in FIG. 4, the first welding transformer 10A includes: a positive electrode conductor 54p which is connected to the second coupling conductor 52b, and rises in an axial direction of the core 12; and a negative electrode conductor 54n which is connected to the third coupling conductor 52c, and rises in the axial direction of the core 12 so as to oppose the second coupling conductor 52b.

Moreover, the plus electrode 22P is connected between the positive electrode conductor 54p and the negative electrode conductor 54n, the first rectifying element 26a is connected between the positive electrode conductor 54p and the plus electrode 22P, and the second rectifying element 26b is connected between the negative electrode conductor 54n and the plus electrode 22P.

Furthermore, the plurality of fourth coupling conductors 52d electrically connecting between the minus electrodes 22N, and the plus electrode 22P are disposed on a side of one end surface 14a of the wound section 14, and the one input terminal 16a and the other input terminal 16b are disposed on a side of the other end surface 14b of the wound section 14.

Thus, in the first welding transformer 10A, the primary winding 18 includes the plurality of first band-shaped conductors 40a covering a part of the core 12, the positive electrode side secondary winding 20p includes the plurality of second band-shaped conductors 40b respectively disposed between the first band-shaped conductors 40a, and the negative electrode side secondary winding 20n includes the plurality of third band-shaped conductors 40c respectively disposed between the first band-shaped conductors 40a and the second band-shaped conductors 40b. Moreover, the second band-shaped conductors 40b each have one end section 40ba (refer to FIG. 5B) to which the positive electrode 50p is connected, and are each wound around with at least one turn. In addition, the third band-shaped conductors 40c each have one end section 40ca (refer to FIG. 5B) to which the negative electrode 50n is connected, and are each wound around with at least one turn. As a result, the wound section 14 can be compactly configured, and downsizing of the first welding transformer 10A can be achieved.

Moreover, since the minus electrodes 22N are each disposed between each of the positive electrodes 50p and each of the negative electrodes 50n, and another end section 40bb (refer to FIG. 5B) of the second band-shaped conductor 40b and another end section 40cb (refer to FIG. 5B) of the third band-shaped conductor 40c are electrically connected, the minus electrode 22N can be easily connected to the wound section 14. In particular, the minus electrode 22N can be tap-connected to the secondary winding 20, and the positive electrode side secondary winding 20p and the negative electrode side secondary winding 20n can be configured in the wound section 14.

Furthermore, according to the first welding transformer 10A having the above-mentioned configuration, the following advantages are exhibited. That is, generally, when frequency is raised, an iron core can be made smaller, hence downsizing of the welding transformer can be achieved. However, when frequency is raised, efficiency of the transformer drops, hence there has been a limit to downsizing.

To address this situation, in the first welding transformer 10A, since rise of a primary current becomes steep, a period during which a secondary voltage can be effectively output can be lengthened, and, even if frequency is raised, efficiency of the transformer can be increased, and, moreover, downsizing can be achieved too.

Now, one experiment example will be described. In this experiment example, primary current waveforms in a working example and a comparative example were confirmed.

The working example has a configuration similar to that of the above-mentioned first welding transformer 10A. The comparative example is a commercially available transformer with a usage condition of frequency 1 kHz. Note that the number of turns of the primary winding and the number of turns of the secondary winding are set the same in each of the working example and comparative example. That is, both in the working example and the comparative example, the primary winding is set to 34 turns, the positive electrode side secondary winding is set to four turns, and the negative electrode side secondary winding is set to four turns.

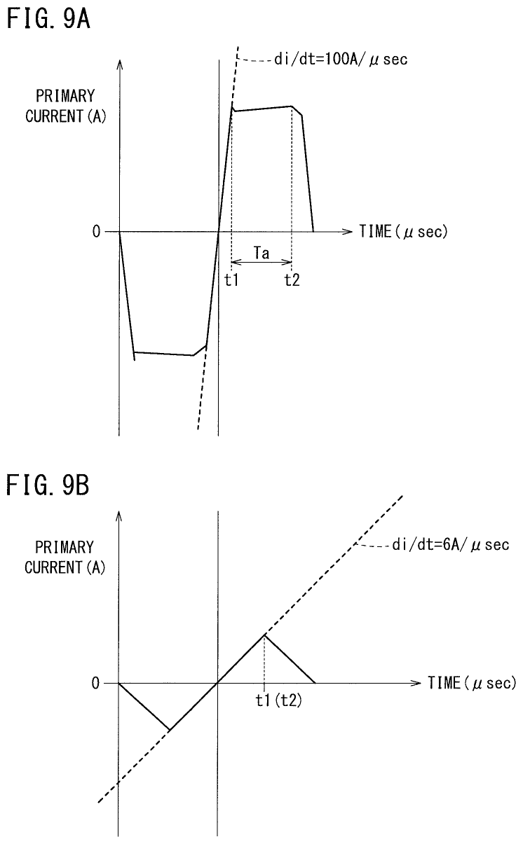

Waveforms of the primary current when a switching frequency of the inverter connected to a prior stage of the welding transformer is set to 10 kHz, are shown in FIGS. 9A and 9B. The waveform of FIG. 9A is the primary current waveform of the working example, and the waveform of FIG. 9B is the primary current waveform of the comparative example.

Usually, a period from a time point t1 when the primary current waveform has risen to a time point t2 when fall has started is an effective period Ta, that is, a period during which a secondary voltage being a welding voltage is effectively output. In order for this effective period Ta to be sufficiently secured, it is required that change in the primary current per unit time di/dt be large, that is, steep.

In the working example, as indicated by the waveform of FIG. 9A, it may be understood that the change di/dt is 100 A/μsec, and that highly efficient power conversion is possible with a high frequency large current.

In contrast, in the comparative example, as indicated by the waveform of FIG. 9B, the change di/dt is gentle at 6 A/μsec, the time point t1 when the primary current waveform has risen and the time point t2 when fall has started are substantially the same, and the effective time Ta could not be secured.

Moreover, in the first welding transformer 10A, the primary winding 18 includes the plurality of first coupling conductors 52a that respectively electrically connect between the first band-shaped conductors 40a, and the positive electrode side secondary winding 20p includes the plurality of second coupling conductors 52b that respectively electrically connect between the positive electrodes 50p. The negative electrode side secondary winding 20n includes the plurality of third coupling conductors 52c that respectively electrically connect between the negative electrodes 50n, and the positive electrode side secondary winding 20p and the negative electrode side secondary winding 20n include the plurality of fourth coupling conductors 52d that respectively electrically connect between the minus electrodes 22N.

Thus, by electrically connecting between the first band-shaped conductors 40a respectively by the first coupling conductors 52a, the primary winding 18 can be configured, and lead-out of the primary winding 18 to outside of the wound section 14 becomes easy. Moreover, by electrically connecting between the positive electrodes 50p respectively by the second coupling conductors 52b, the positive electrode side secondary winding 20p can be configured, and lead-out of the positive electrode side secondary winding 20p to outside of the wound section 14 becomes easy. Similarly, by electrically connecting between the negative electrodes 50n respectively by the third coupling conductors 52c, the negative electrode side secondary winding 20n can be configured, and lead-out of the negative electrode side secondary winding 20n to outside of the wound section 14 becomes easy.

In the first welding transformer 10A, the plurality of first coupling conductors 52a are formed on the other end surface 14b of the wound section 14. In this case, the one input terminal 16a is connected to the first coupling conductor 52a positioned on the outer circumferential side of the wound section 14, among the plurality of first coupling conductors 52a. The other input terminal 16b is connected to the first coupling conductor 52a positioned on the inner circumferential side of the wound section 14, among the plurality of first coupling conductors 52a.

That is, since the first coupling conductors 52a are formed on the other end surface 14b of the wound section 14, in-betweens of the first band-shaped conductors 40a can be easily electrically connected by the first coupling conductors 52a, and the primary winding 18 can be easily configured. Moreover, lead-out of the primary winding 18 to outside of the wound section 14 becomes easy too. As a result, the one input terminal 16a can be connected to the first coupling conductor 52a positioned on the inner circumferential side of the wound section 14, among the plurality of first coupling conductors 52a, and the other input terminal 16b can be connected to the first coupling conductor 52a positioned on the outer circumferential side of the wound section 14, among the plurality of first coupling conductors 52a.

In the first welding transformer 10A, the core 12 includes the two long parallel sections (the first parallel section 30a and the second parallel section 30b). The wound section 14 is wound around either one of the parallel sections (for example, the first parallel section 30a). Moreover, at least one coupling direction of the coupling direction of the first coupling conductor 52a, the coupling direction of the second coupling conductor 52b, the coupling direction of the third coupling conductor 52c, and the coupling direction of the fourth coupling conductor 52d, and the long direction of the first parallel section 30a and the second parallel section 30b, are in an intersecting positional relationship.

This makes it possible for the first coupling conductor 52a to be disposed in the upper section or lower section of the wound section 14, and for any one of the second coupling conductor 52b, the third coupling conductor 52c, and the fourth coupling conductor 52d to be disposed in the lower section or upper section of the wound section 14, and contributes to the first welding transformer 10A being made compact. In particular, by configuring all of the coupling directions of the second coupling conductor 52b, the third coupling conductor 52c, and the fourth coupling conductor 52d to be in an intersecting positional relationship with the long direction of the first parallel section 30a and the second parallel section 30b, all of the second coupling conductor 52b, the third coupling conductor 52c, and the fourth coupling conductor 52d can be disposed in the lower section or upper section of the wound section 14, and even more compacting of the first welding transformer 10A can be achieved.

In the first welding transformer 10A, at least the coupling direction of the second coupling conductor 52b and the coupling direction of the third coupling conductor 52c are the same. Thus, the second coupling conductor 52b and the third coupling conductor 52c can be disposed in parallel to be configured as one pedestal 56 (refer to FIG. 4), and the first rectifying element 26a, the second rectifying element 26b, the plus electrode 22P, and so on can be disposed on this pedestal 56. As a result, compacting of the first welding transformer 10A can be achieved.

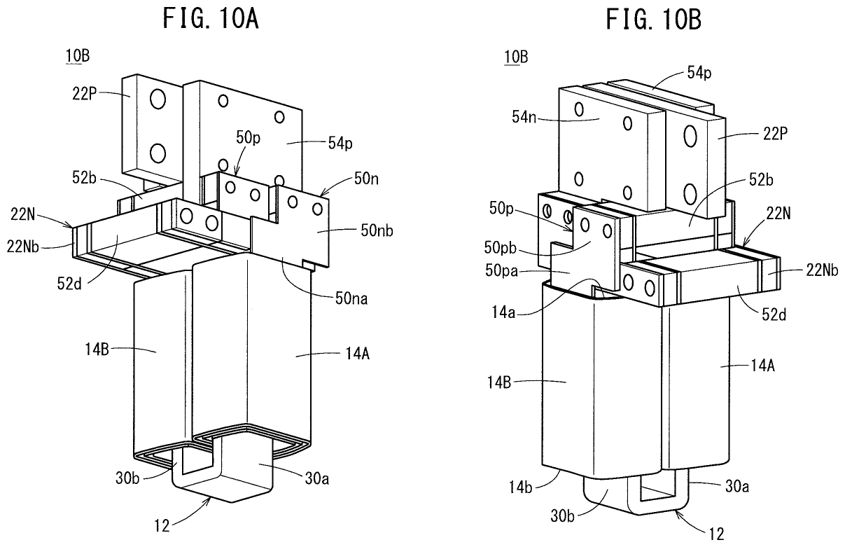

Next, a welding transformer according to a second embodiment (hereafter, written as second welding transformer 10B) will be described with reference to FIGS. 10A-15.

The second welding transformer 10B has a configuration substantially similar to that of the above-mentioned first welding transformer 10A, but differs in the following points.

As shown in FIGS. 10A and 10B, the wound section 14 includes: a first wound section 14A wound around the first parallel section 30a of the annular core 12; and a second wound section 14B wound around the second parallel section 30b of the annular core 12.

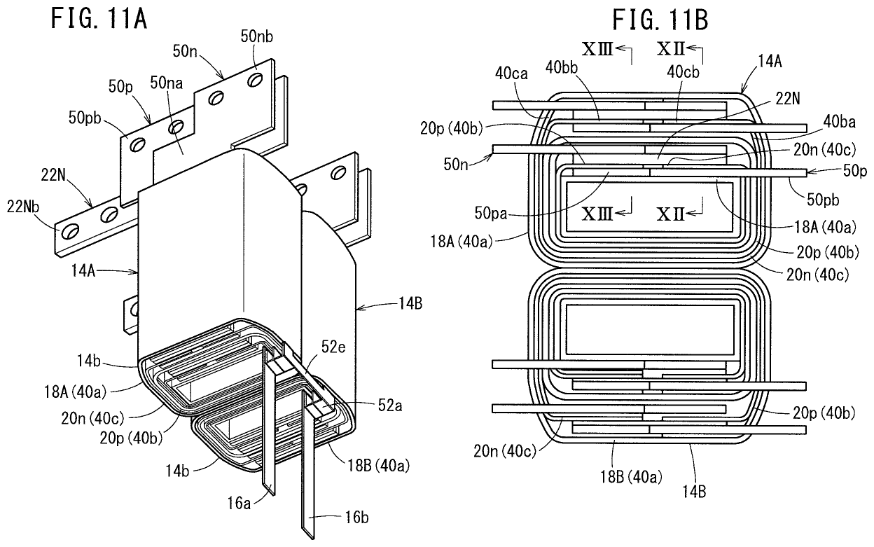

As shown in FIGS. 11A and 11B, a first primary winding 18A configuring the first wound section 14A includes, for example, three first band-shaped conductors 40a covering the first parallel section 30a of the core 12 (refer to FIG. 10A). The positive electrode side secondary winding 20p includes, for example, two second band-shaped conductors 40b respectively disposed between the first band-shaped conductors 40a. The negative electrode side secondary winding 20n includes, for example, two third band-shaped conductors 40c respectively disposed between the first band-shaped conductors 40a and the second band-shaped conductors 40b.

Similarly, a second primary winding 18B configuring the second wound section 14B includes, for example, three first band-shaped conductors 40a covering the second parallel section 30b of the core 12 (refer to FIG. 10A). The positive electrode side secondary winding 20p includes, for example, two second band-shaped conductors 40b respectively disposed between the first band-shaped conductors 40a. The negative electrode side secondary winding 20n includes, for example, two third band-shaped conductors 40c respectively disposed between the first band-shaped conductors 40a and the second band-shaped conductors 40b.

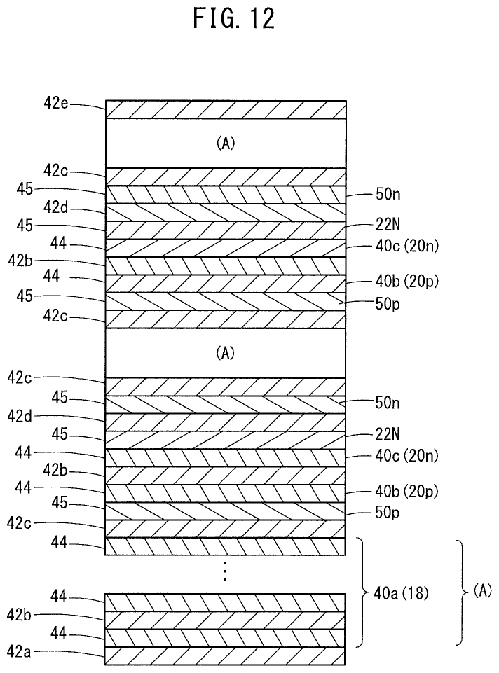

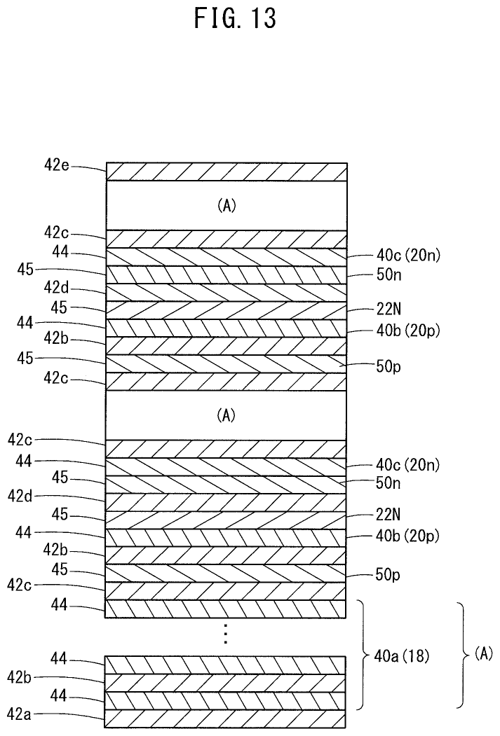

Note that, as shown in FIGS. 12 and 13, the first band-shaped conductor 40a, the second band-shaped conductor 40b, and the third band-shaped conductor 40c have the following configurations, although duplicated descriptions of their inner configurations will be omitted due to them being substantially the same as in the above-mentioned first welding transformer 10A.

That is, in the first wound section 14A and the second wound section 14B, among the three first band-shaped conductors 40a, the outermost side first band-shaped conductor 40a has at least one turn, for example, five turns of the conductive films 44 wound around therein, the central first band-shaped conductor 40a has at least one turn, for example, eight turns of the conductive films 44 wound around therein, and the innermost side first band-shaped conductor 40a has at least one turn, for example, five turns of the conductive films 44 wound around therein. That is, a total of at least three turns, for example, 18 turns of the conductive films 44 are wound around per one wound section.

The second band-shaped conductor 40b has one end section 40ba (refer to FIG. 11B) to which the positive electrode 50p is connected, and is wound around with at least one turn. The single inter-winding insulating film 42c is interposed between the innermost side conductive film 44 of the first band-shaped conductor 40a and the conductive film 44 of the second band-shaped conductor 40b.

The third band-shaped conductor 40c has one end section 40ca (refer to FIG. 11B) to which the negative electrode 50n is connected, and is wound around with at least one turn. The single inter-winding insulating film 42c is interposed between the conductive film 44 of the second band-shaped conductor 40b and the conductive film 44 of the third band-shaped conductor 40c.

Moreover, as shown in FIG. 11B, the minus electrodes 22N electrically connecting the other end sections 40bb of the second band-shaped conductors 40b and the other end sections 40cb of the third band-shaped conductors 40c are each disposed between each of the positive electrodes 50p and each of the negative electrodes 50n.

The outer insulating film 42e (refer to FIG. 12) is disposed on the outside of the most outwardly positioned first band-shaped conductor 40a, among the three first band-shaped conductors 40a of each of the above-mentioned first wound section 14A and second wound section 14B.

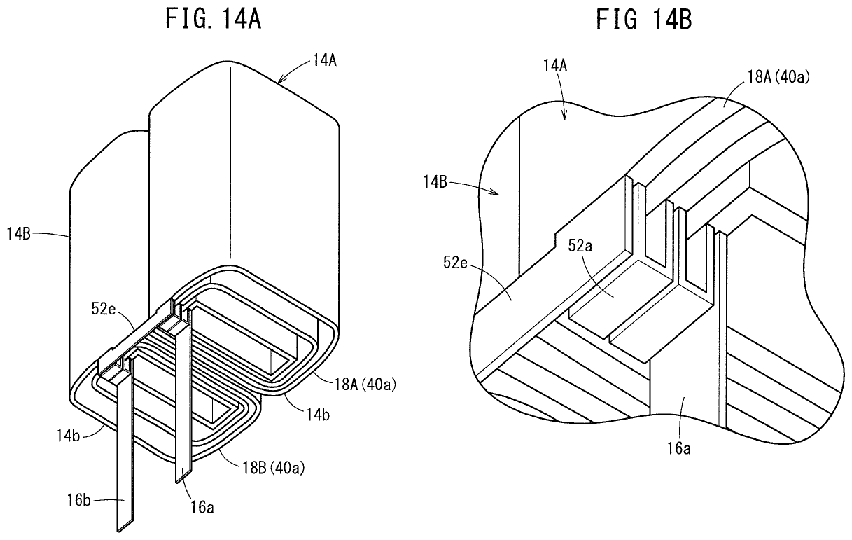

Moreover, as shown in FIGS. 11A, 14A, and 14B, the first wound section 14A includes a plurality of the first coupling conductors 52a, for example, two first coupling conductors 52a that respectively electrically connect between the first band-shaped conductors 40a. Similarly, the second wound section 14B includes a plurality of the first coupling conductors 52a, for example, two first coupling conductors 52a that respectively electrically connect between the first band-shaped conductors 40a. Moreover, there is included a fifth coupling conductor 52e that electrically connects at least one first band-shaped conductor 40a of the first wound section 14A and at least one first band-shaped conductor 40a of the second wound section 14B.

That is, the two first coupling conductors 52a in the first wound section 14A are formed on the other end surface 14b of the first wound section 14A, and the two first coupling conductors 52a in the second wound section 14B are formed on the other end surface 14b of the second wound section 14B.

Furthermore, the fifth coupling conductor 52e is connected between the first coupling conductor 52a formed in the first wound section 14A and the first coupling conductor 52a formed in the second wound section 14B. Specifically, one end section of the fifth coupling conductor 52e is connected to a position corresponding to the first coupling conductor 52a positioned on an outer circumferential side or an inner circumferential side of the first wound section 14A, of the two first coupling conductors 52a formed in the first wound section 14A. Another end section of the fifth coupling conductor 52e is connected to a position corresponding to the first coupling conductor 52a positioned on an outer circumferential side or an inner circumferential side of the second wound section 14B, of the two first coupling conductors 52a formed in the second wound section 14B. In the example of FIGS. 11A and 14A, the fifth coupling conductor 52e is connected from a position corresponding to the first coupling conductor 52a provided on the outer circumferential side of the first wound section 14A to a position corresponding to the first coupling conductor 52a provided on the outer circumferential side of the second wound section 14B.

Furthermore, the one input terminal 16a is connected to the first coupling conductor 52a positioned on the outer circumferential side or the inner circumferential side of the first wound section 14A, and the other input terminal 16b is connected to the first coupling conductor 52a positioned on the outer circumferential side or the inner circumferential side of the second wound section 14B. In the example of FIGS. 11A and 14A, the one input terminal 16a is connected to the first coupling conductor 52a positioned on the inner circumferential side of the first wound section 14A, and the other input terminal 16b is connected to the first coupling conductor 52a positioned on the inner circumferential side of the second wound section 14B.

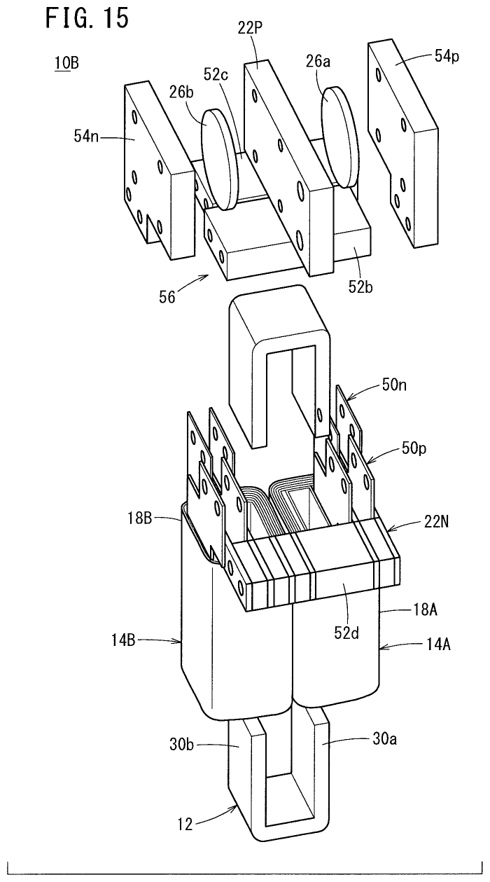

Moreover, in this second welding transformer 10B, as shown in FIGS. 10A, 10B, and 15, at least one coupling direction of the coupling direction of the first coupling conductor 52a, the coupling direction of the second coupling conductor 52b, the coupling direction of the third coupling conductor 52c, and the coupling directions of the fourth coupling conductor 52d and the fifth coupling conductor 52e, and the long direction of the first parallel section 30a and the second parallel section 30b, are in an intersecting positional relationship. In this example too, an intersecting relationship refers to a relationship where an angle made by the at least one coupling direction and the long direction of the parallel section is 60°-120°, and, preferably, is 90° (an orthogonal relationship). In this second welding transformer 10B, all of the coupling direction of the first coupling conductor 52a, the coupling direction of the second coupling conductor 52b, the coupling direction of the third coupling conductor 52c, the coupling direction of the fourth coupling conductor 52d, and the coupling direction of the fifth coupling conductor 52e, and the long direction of the first parallel section 30a and the second parallel section 30b, are in an intersecting positional relationship.

Thus, the second welding transformer 10B exhibits the following advantages in addition to having a configuration similar to that of the above-mentioned first welding transformer 10A.

That is, even in the case where the wound section 14 is configured by the first wound section 14A and the second wound section 14B, one primary winding 18 can be configured by electrically connecting the first coupling conductor 52a of the first wound section 14A and the first coupling conductor 52a of the second wound section 14B by the fifth coupling conductor 52e. Therefore, the welding transformer of a type having one wound section 14 and the welding transformer of a type having two wound sections 14 can be provided, and selection can be made variously according to application.

In the second welding transformer 10B, among the plurality of first coupling conductors 52a, some first coupling conductors 52a can be formed on the other end surface 14b of the first wound section 14A (refer to FIG. 11A), and other first coupling conductors 52a can be formed on the other end surface 14b of the second wound section 14B (refer to FIG. 11A). Moreover, the fifth coupling conductor 52e can be connected to the first coupling conductor 52a positioned on the outer circumferential side or the inner circumferential side of the first wound section 14A, among the some first coupling conductors 52a, and to the first coupling conductor 52a positioned on the outer circumferential side or the inner circumferential side of the second wound section 14B, among the other first coupling conductors 52a.

As a result, in-betweens of the first band-shaped conductors 40a in the first wound section 14A can be easily electrically connected by the some first coupling conductors 52a. Similarly, in-betweens of the first band-shaped conductors 40a in the second wound section 14B can be easily electrically connected by the other first coupling conductors 52a. That is, one primary winding 18 can be easily configured spanning the first wound section 14A and the second wound section 14B. Moreover, lead-out of the primary winding 18 to outside of the first wound section 14A and to outside of the second wound section 14B becomes easy too.

As a result, the one input terminal 16a can be connected to the first coupling conductor 52a positioned on the inner circumferential side or the outer circumferential side of the first wound section 14A, among the some of the first coupling conductors 52a, and the other input terminal 16b can be connected to the first coupling conductor 52a positioned on the inner circumferential side or the outer circumferential side of the second wound section 14B, among the other first coupling conductors 52a.

As mentioned above, at least one coupling direction of the coupling direction of the first coupling conductor 52a, the coupling direction of the second coupling conductor 52b, the coupling direction of the third coupling conductor 52c, the coupling direction of the fourth coupling conductor 52d, and the coupling direction of the fifth coupling conductor 52e, and the long direction of the first parallel section 30a and the second parallel section 30b, are in an intersecting positional relationship.

This makes it possible for the first coupling conductor 52a to be disposed in upper sections or lower sections of the first wound section 14A and the second wound section 14B, and for any one of the second coupling conductor 52b, the third coupling conductor 52c, and the fourth coupling conductor 52d to be disposed in the lower sections or upper sections of the first wound section 14A and the second wound section 14B, and contributes to the welding transformer being made compact. In particular, by configuring at least one, and preferably all of the coupling directions of the second coupling conductor 52b, the third coupling conductor 52c, and the fourth coupling conductor 52d to be in an intersecting positional relationship with the long direction of the first parallel section 30a and the second parallel section 30b, at least one, and preferably all of the second coupling conductor 52b, the third coupling conductor 52c, and the fourth coupling conductor 52d can be disposed in the lower sections or upper sections of the first wound section 14A and the second wound section 14B, and even more compacting of the welding transformer can be achieved.

Moreover, in the second welding transformer 10B, at least the coupling direction of the second coupling conductor 52b, the coupling direction of the third coupling conductor 52c, and the coupling direction of the fifth coupling conductor 52e are the same. Thus, the second coupling conductor 52b and the third coupling conductor 52c can be disposed in parallel to be configured as one pedestal 56, and the first rectifying element 26a, the second rectifying element 26b, the plus electrode 22P, and so on can be disposed on this pedestal 56. As a result, compacting of the welding transformer can be achieved. Moreover, since the coupling direction of the fifth coupling conductor 52e is also the same, lead-out directions of the one input terminal 16a and the other input terminal 16b can be easily grasped too, and mounting work of the welding transformer becomes easy.

Note that the welding transformer according to the present invention is not limited to the above-mentioned embodiments, and it goes without saying that a variety of configurations may be adopted without departing from the spirit of the present invention. For example, a winding conductor section (all or some of the wound section, the positive electrode, the negative electrode, the minus electrode, and the coupling conductors) may be provided with a porous structure or hollow structure for circulating a cooling medium, or a pipe for cooling or the like may be provided adjacent to the above-described winding conductor section or the iron core.

1. A welding transformer comprising:
a core; and
a primary winding and a secondary winding wound alternately around the core,
the primary winding including a first band-shaped conductor whose width direction extends in parallel to a direction of a magnetic flux passing through the core,
the secondary winding including a second band-shaped conductor whose width direction extends in parallel to the direction of the magnetic flux passing through the core, and
the first band-shaped conductor and the second band-shaped conductor being laminated alternately in a direction orthogonal to the direction of the magnetic flux.

2. The welding transformer according to claim 1, wherein
the secondary winding includes a positive electrode side secondary winding and a negative electrode side secondary winding, and
the primary winding, the positive electrode side secondary winding, and the negative electrode side secondary winding are wound around the core in this order, or the primary winding, the negative electrode side secondary winding, and the positive electrode side secondary winding are wound around the core in this order.

3. The welding transformer according to claim 2, comprising:
the core having an annular shape;
a wound section wound around the core and including the primary winding connected between one input terminal and another input terminal, the positive electrode side secondary winding, and the negative electrode side secondary winding;
a minus electrode connected to a connecting point of the positive electrode side secondary winding and the negative electrode side secondary winding; and
a plus electrode connected via a first rectifying element to the positive electrode side secondary winding and connected via a second rectifying element to the negative electrode side secondary winding.

4. The welding transformer according to claim 3, wherein
the primary winding includes a plurality of the first band-shaped conductors covering a part of the core,
the positive electrode side secondary winding includes a plurality of the second band-shaped conductors respectively disposed between the first band-shaped conductors,
the negative electrode side secondary winding includes a plurality of third band-shaped conductors respectively disposed between the first band-shaped conductors and the second band-shaped conductors,
the second band-shaped conductors each have one end section to which a positive electrode is connected, and are each wound around with at least one turn,
the third band-shaped conductors each have one end section to which a negative electrode is connected, and are each wound around with at least one turn, and
the minus electrode electrically connecting another end section of the second band-shaped conductor and another end section of the third band-shaped conductor is disposed between each of the positive electrodes and each of the negative electrodes.

5. The welding transformer according to claim 4, wherein
the primary winding includes a plurality of first coupling conductors configured to respectively electrically connect between the first band-shaped conductors,
the positive electrode side secondary winding includes a plurality of second coupling conductors configured to respectively electrically connect between the positive electrodes,
the negative electrode side secondary winding includes a plurality of third coupling conductors configured to respectively electrically connect between the negative electrodes, and
the positive electrode side secondary winding and the negative electrode side secondary winding include a plurality of fourth coupling conductors configured to respectively electrically connect between the minus electrodes.

6. The welding transformer according to claim 5, wherein
the plurality of first coupling conductors are formed on one end surface of the wound section,
the one input terminal is connected to the first coupling conductor positioned on an outer circumferential side of the wound section, among the plurality of first coupling conductors, and
the other input terminal is connected to the first coupling conductor positioned on an inner circumferential side of the wound section, among the plurality of first coupling conductors.

7. The welding transformer according to claim 5, wherein
the core includes two long parallel sections,
the wound section is wound around either one of the parallel sections, and
at least one coupling direction of a coupling direction of the first coupling conductor, a coupling direction of the second coupling conductor, a coupling direction of the third coupling conductor, and a coupling direction of the fourth coupling conductor, and a long direction of the parallel section, are in an intersecting positional relationship.

8. The welding transformer according to claim 7, wherein
at least the coupling direction of the second coupling conductor is identical to the coupling direction of the third coupling conductor.

9. The welding transformer according to claim 8, wherein
the wound section includes: a first wound section wound around one of the parallel sections; and a second wound section wound around another of the parallel sections, and
the wound section further includes a fifth coupling conductor configured to electrically connect at least one of the first band-shaped conductors of the first wound section and at least one of the first band-shaped conductors of the second wound section.

10. The welding transformer according to claim 9, wherein
one group of one or more first coupling conductors, among the plurality of first coupling conductors, is formed on one end surface of the first wound section,
another group of one or more first coupling conductors, among the plurality of first coupling conductors, is formed on one end surface of the second wound section,
the fifth coupling conductor is connected from a position corresponding to the first coupling conductor positioned on an outer circumferential side or an inner circumferential side of the first wound section, among the one or more first coupling conductors of the one group, to a position corresponding to the first coupling conductor positioned on an outer circumferential side or an inner circumferential side of the second wound section, among the one or more first coupling conductors of the other group,
the one input terminal is connected to the first coupling conductor positioned on the inner circumferential side or the outer circumferential side of the first wound section, among the one or more first coupling conductors of the one group, and
the other input terminal is connected to the first coupling conductor positioned on the inner circumferential side or the outer circumferential side of the second wound section, among the one or more first coupling conductors of the other group.

11. The welding transformer according to claim 9, wherein
the core includes two long parallel sections,
the first wound section is wound around either one of the parallel sections,
the second wound section is wound around either another of the parallel sections, and
at least one coupling direction of a coupling direction of the first coupling conductor, a coupling direction of the second coupling conductor, a coupling direction of the third coupling conductor, and coupling directions of the fourth coupling conductor and the fifth coupling conductor, and a long direction of the parallel section, are in an intersecting positional relationship.

12. The welding transformer according to claim 11, wherein
at least the coupling direction of the second coupling conductor, the coupling direction of the third coupling conductor, and the coupling direction of the fifth coupling conductor are identical.

13. The welding transformer according to claim 5, further comprising:
a positive electrode conductor connected to the second coupling conductor; and a negative electrode conductor connected to the third coupling conductor,
wherein the plus electrode is connected between the positive electrode conductor and the negative electrode conductor,
the first rectifying element is connected between the positive electrode conductor and the plus electrode, and
the second rectifying element is connected between the negative electrode conductor and the plus electrode.

14. The welding transformer according to claim 5, wherein
the plurality of fourth coupling conductors electrically connecting between the minus electrodes, and the plus electrode are disposed on one end surface side of the wound section, and
the one input terminal and the other input terminal are disposed on another end surface side of the wound section.
